(19) United States
(12) Patent Application Publication
(10) Pub. No.: US 2014/0176765 A1
(43) Pub. Date: Jun. 26, 2014

(54) ELECTRONIC DEVICE AND METHOD FOR ADJUSTING SPECIFIC PARAMETERS THEREOF

(71) Applicant: HON HAI PRECISION INDUSTRY CO., LTD., New Taipei (TW)

(72) Inventor: I-Yen Fang, New Taipei (TW)

(73) Assignee: HON HAI PRECISION INDUSTRY CO., LTD., New Taipei (TW)

(21) Appl. No.: 14/140,547

(22) Filed: Dec. 26, 2013

(30) Foreign Application Priority Data
Dec. 26, 2012 (TW) 101149978

(51) Int. Cl. H04N 5/232

(52) U.S. Cl. CPC H04N 5/23219
USPC 348/231.99

(57) ABSTRACT

A method for adjusting specific parameters for an electronic device is provided. The method includes the following steps. First, the picture signals are generated in response to capture a picture automatically when each time a predetermined time interval elapses. Second, a picture is identified according to the picture signals. Third, an adjustment type and an adjustment ratio are determined according to a comparison of the identified picture and the predefined picture when the identified picture contains a facial image. Four, the specific parameters for the electronic device is adjusted according to the comparison of the determined adjustment type and adjustment ratio. Lastly, the contents are outputted from the electronic device according to the adjusted parameters. An electronic device which applies the method for adjusting the specific parameters is also provided.

### BACKGROUND

1. Technical Field

The present disclosure relates to an electronic device and a method for adjusting specific parameters for the electronic device.

2. Description of Related Art

Nowadays, to increase convenience, many kinds of compact electronic devices are available to the consumer. However, the display screen of a typical compact electronic device is correspondingly small, which makes viewing very tiring. In addition, the display scale of the display screen is only able to be adjusted manually, and other functions of the electronic device (such as volume adjustment) are only able to be adjusted manually. This may be inconvenient for a user, especially for a disabled user.

Therefore, what is needed is an electronic device and a method which can alleviate or even overcome the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts or sections throughout the views.

FIG. 1 is a block diagram of an electronic device in accordance with an embodiment of the present invention.

FIGS. 2 and 3 cooperatively show a relationship between a distance of a user from the electronic device of FIG. 1 and a size of a captured picture of the user, in accordance with an embodiment of the present invention.

FIGS. 4 and 5 together constitute a single flowchart of a method for adjusting specific parameters for an electronic device, such as the one of FIG. 1, in accordance with an embodiment of the present invention.

FIG. 6 is a flowchart of a method for calibrating predefined specific parameters for an electronic device, such as the one of FIG. 1, in accordance with an embodiment of the present invention.

### DETAILED DESCRIPTION

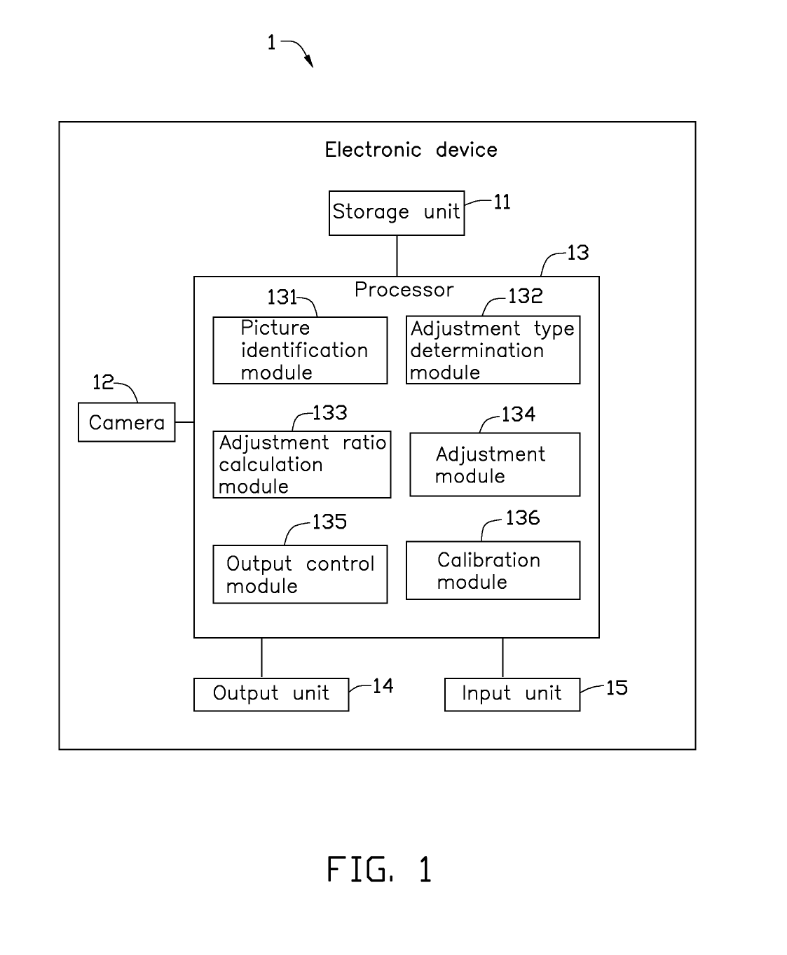

FIG. 1 illustrates an embodiment of an electronic device 1. The electronic device 1 includes a storage unit 11, a camera 12, a processor 13, and an output unit 14.

The storage unit 11 stores a predefined picture, a predefined display scale, and a predefined output volume. The predefined picture contains a facial image.

The camera 12 is installed on a main body of the electronic device 1. Once the camera 12 is activated, and then each time a predetermined time interval elapses, the camera 12 automatically captures a picture and generates a corresponding picture signal.

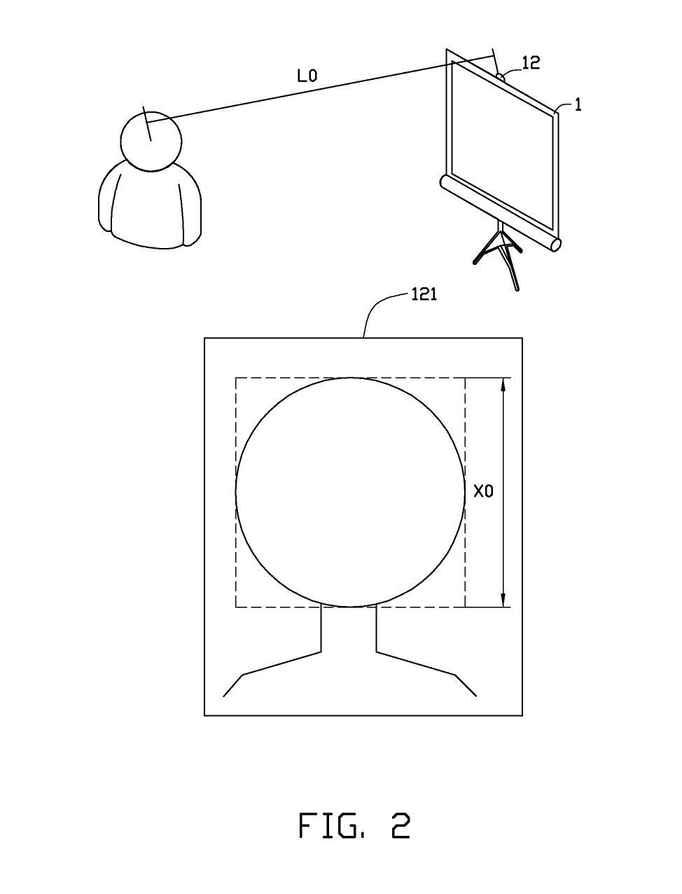

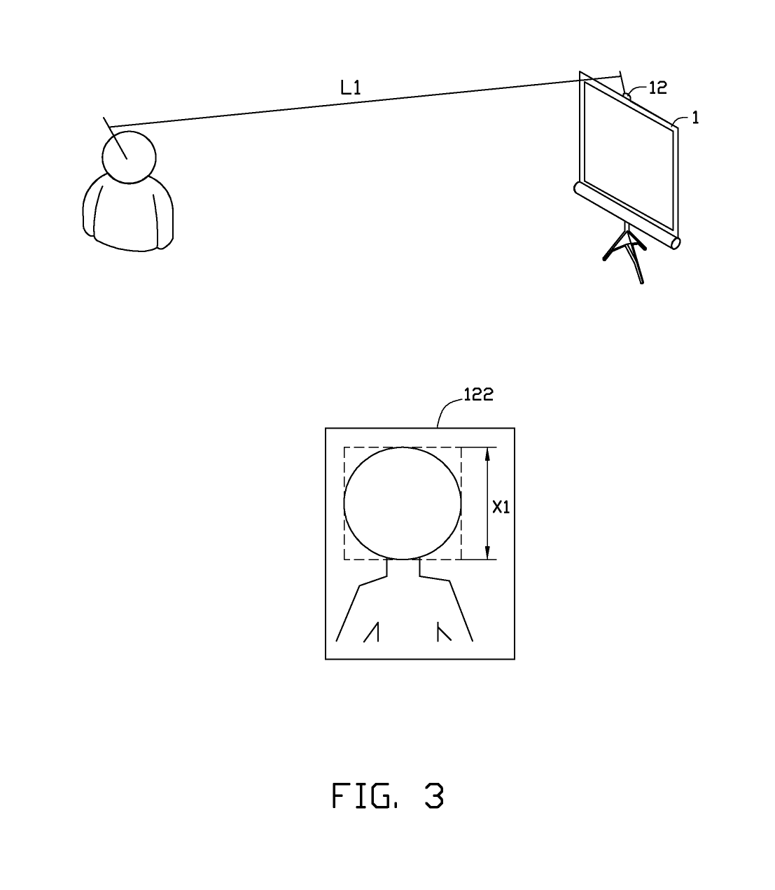

FIGS. 2 and 3 cooperatively show a relationship between a distance of a user from the electronic device 1 and a size of a captured picture of the user. FIG. 2 shows that the user sits in the front of the electronic device 1 and the distance between the user and the electronic device 1 is L0. The camera 12 captures a picture 121 containing a facial image of the user, and the length of face in the captured picture is X0.

FIG. 3 shows that the distance between the user and the electronic device 1 is L1, which is larger than L0. The camera 12 captures a picture 122 containing a facial image of the user again, and the length of the face in the captured picture is X1. As the distance L1 is greater that the distance L0, the length X1 is less than the length X0. In other words, when the user moves away from the electronic device 1, the length of the face in the captured picture is reduced correspondingly. Conversely, when the user moves towards the electronic device 1, the length of the face in the captured picture is enlarged correspondingly.

The processor 13 includes a picture identification module 131, an adjustment type determination module 132, an adjustment ratio calculation module 133, an adjustment module 134, and an output control module 135.

The picture identification module 131 is configured for identifying a picture according to a picture signal, and for determining whether the identified picture contains a facial image.

The adjustment type determination module 132 is configured for determining an adjustment type according to the identified picture and the predefined picture when the identified picture contains a facial image. In detail, the adjustment type determination module 132 is configured for comparing the obtained facial image in the identified picture with the facial image in the predefined picture stored in the storage unit 11, and for determining whether a size of a face in the identified picture is larger than a size of a face in the predefined picture. If the size of the face in the identified picture is larger than the size of the face in the predefined picture, the adjustment type determination module 132 is further configured for determining that the user is moving towards the electronic device 1 and that accordingly the adjustment type is an adjusting down type. Otherwise, the adjustment type determination module 132 is further configured for determining that the user is moving away from the electronic device 1 and that accordingly the adjustment type is an adjusting up type.

In another embodiment, the adjustment type determination module 132 is configured for determining whether a size of a feature such as a nose in the identified picture is larger than a size of a counterpart feature in the predefined picture. If so, the adjustment type determination module 132 is further configured for determining that the user is moving towards the electronic device 1 and that accordingly the adjustment type is an adjusting up type. Otherwise, the adjustment type determination module 132 is further configured for determining that the user is moving away from the electronic device 1 and that accordingly the adjustment type is an adjusting down type. In other embodiments, the feature whose size is assessed can be an eye, and/or a pair of eyeglasses, for example.

The adjustment ratio calculation module 133 is configured for determining an adjustment ratio according to the identified picture and the predefined picture when the identified picture contains a facial image. In detail, the adjustment ratio calculation module 133 is configured for calculating a ratio R0 between the size of the face in the predefined picture and the size of the face in the identified picture, and for calculating the adjustment ratio R according to the calculated ratio R0. The adjustment ratio R can be calculated as R=R0, or R=(1−R0)/R0, for example. In another embodiment, the adjustment ratio calculation module 133 is configured for calculating a ratio R0 between the size of a feature of the face such as a nose in the predefined picture and the size of a counterpart feature of the face such as a nose in the identified picture. In other embodiments, the feature whose size is assessed can be an eye, and/or a pair of eyeglasses, for example.

The adjustment module 134 is configured for adjusting one or more specific parameters according to the determined adjustment type, the determined adjustment ratio R and a predetermined adjustment factor.

In this embodiment, the specific parameters include a display scale of a display (not shown) of the electronic device 1. The adjustment module 134 is configured for adjusting the display scale according to a determined adjustment type, a determined adjustment ratio R and a predetermined adjustment factor. Here, the predetermined adjustment factor is a predefined display scale. If the determined adjustment type is an adjusting up type, the predefined display scale is 100%, and the determined adjustment ratio R is 1.5, then the display scale is equal to the predefined display scale multiplied by the adjustment ratio R. That is, the display scale is 150%, therefore the adjustment module 134 adjusts the display scale to be 150%.

Furthermore, in this embodiment, the specific parameters further include an output volume of a speaker (not shown) of the electronic device 1. The adjustment module 134 is configured for adjusting the output volume according to a determined adjustment type, a determined adjustment ratio R and a predetermined adjustment factor. Here, the predetermined adjustment factor is a predefined output volume. If the determined adjustment type is an adjusting up type, the predefined output volume is 20 dB (decibels), and the determined adjustment ratio R is 1.5, then the output volume is equal to the predefined output volume multiplied by the adjustment ratio R. That is, the output volume is increased by 1.5 times, therefore the adjustment module 134 adjusts the output volume to be 30 dB.

The output control module 135 is configured for controlling the output unit 14 to output contents from the electronic device 1 according to the adjusted specific parameters. In this embodiment, the output control module 135 is configured for controlling the output unit 14 to output the contents from the electronic device 1 according to the adjusted display scale and adjusted output volume correspondingly.

In the above-described embodiment, the specific parameters comprise a display scale and an output volume. In other embodiments, there may be only a single specific parameter, such as the display scale or the output volume. In still other embodiments, the specific parameters can be other kinds of parameters of the electronic device 1.

In this embodiment, the electronic device 1 further includes an input unit 15. The input unit 15 includes one or more mechanical keys and/or one or more virtual keys. The input unit 15 is configured for generating a signal for calibrating a predefined display scale or a predefined output volume in response to instruction operations applied on the mechanical keys or the virtual keys by a user.

In this embodiment, the processor 13 further includes a calibration module 136. The calibration module 136 is configured for calibrating the predefined display scale or the predefined output volume according to the signal for calibrating the predefined display scale or the predefined output volume.

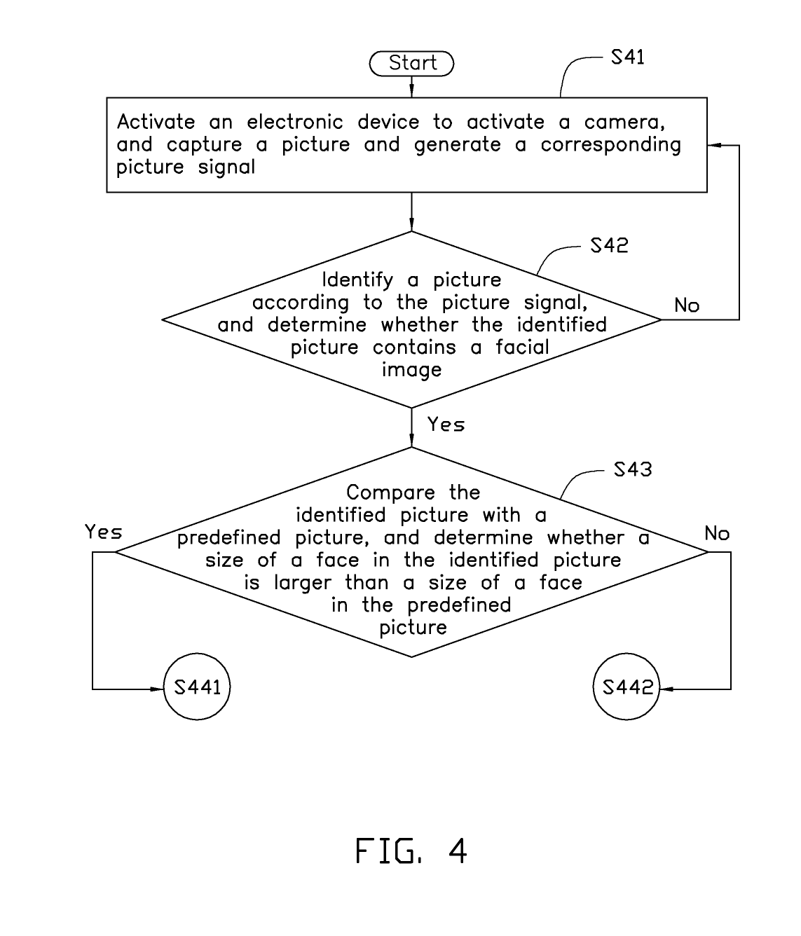

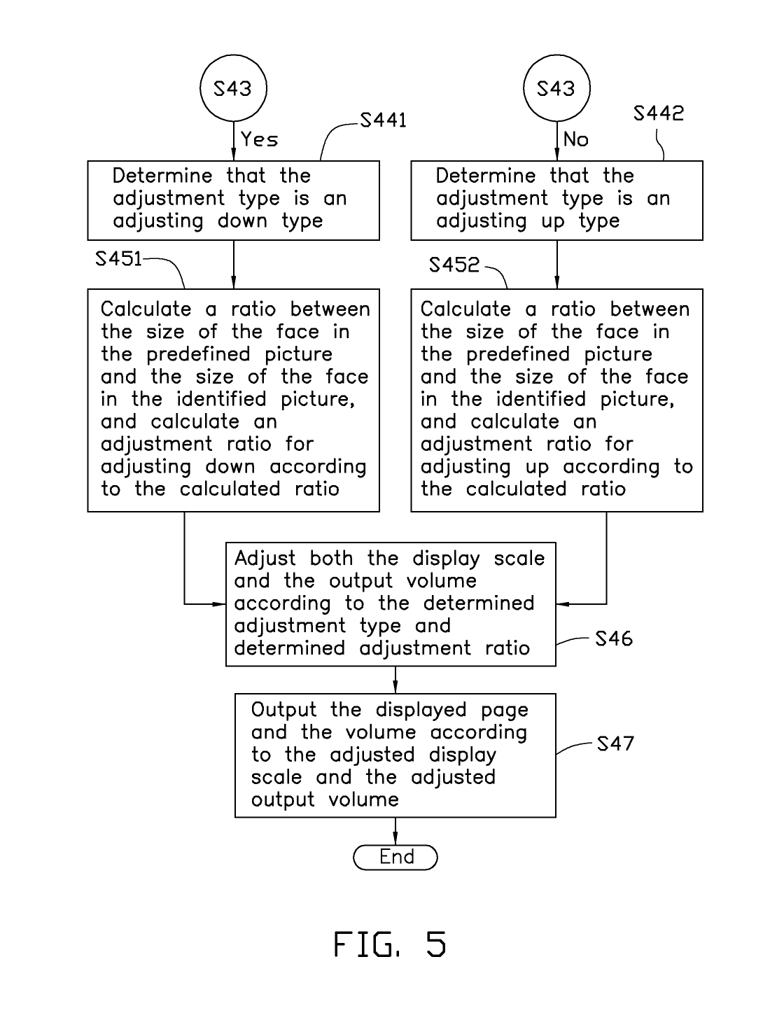

FIGS. 4 and 5 together constitute a single flowchart of a method for simultaneously adjusting display scale and output volume for an electronic device such as the electronic device 1. The electronic device 1 includes a storage unit 11 and a camera 12. The storage unit 11 stores a predefined picture, a predefined display scale and a predefined output volume. The predefined picture contains a facial image. Once the camera 12 is activated, and then each time a predetermined time interval elapses, the camera 12 automatically captures a picture and generates a picture signal. The method typically includes the following steps, each of which is related to the various components contained in the electronic device 1.

In step S41, when the electronic device 1 is activated, the camera 12 is correspondingly activated. Accordingly, the camera 12 automatically captures a picture and generates a corresponding picture signal. The picture capturing and picture signal generating of step S41 are also performed again later on, each time a predetermined time interval elapses.

In step S42, the picture identification module 131 identifies a picture according to the picture signal, and determines whether the identified picture contains a facial image. If the determination is yes, the process goes to step S43. Otherwise, the process goes back to the beginning of step S42.

In step S43, the adjustment type determination module 132 compares the identified picture with the predefined picture, and determines whether a size of a face in the identified picture is larger than a size of a face in the predefined picture. If the determination is yes, the process goes to step S441. Otherwise, the process goes to step S442.

In step S441, the adjustment type determination module 132 determines that the adjustment type is an adjusting down type.

In step S442, the adjustment type determination module 132 determines that the adjustment type is an adjusting up type.

In step S451, the adjustment ratio calculation module 133 calculates a ratio R0 between the size of the face in the predefined picture and the size of the face in the identified picture, in order to calculate an adjustment ratio R for adjusting down according to the calculated ratio R0.

In step S452, the adjustment ratio calculation module 133 calculates a ratio R0 between the size of the face in the predefined picture and the size of the face in the identified picture, in order to calculate an adjustment ratio R for adjusting up according to the calculated ratio R0.

In step S46, the adjustment module 134 adjusts both the display scale and the output volume according to the determined adjustment type and determined adjustment ratio R.

In step S47, the output control module 135 controls the output unit 14 to output the displayed page and the volume from the electronic device 1 according to the adjusted display scale and the adjusted output volume.

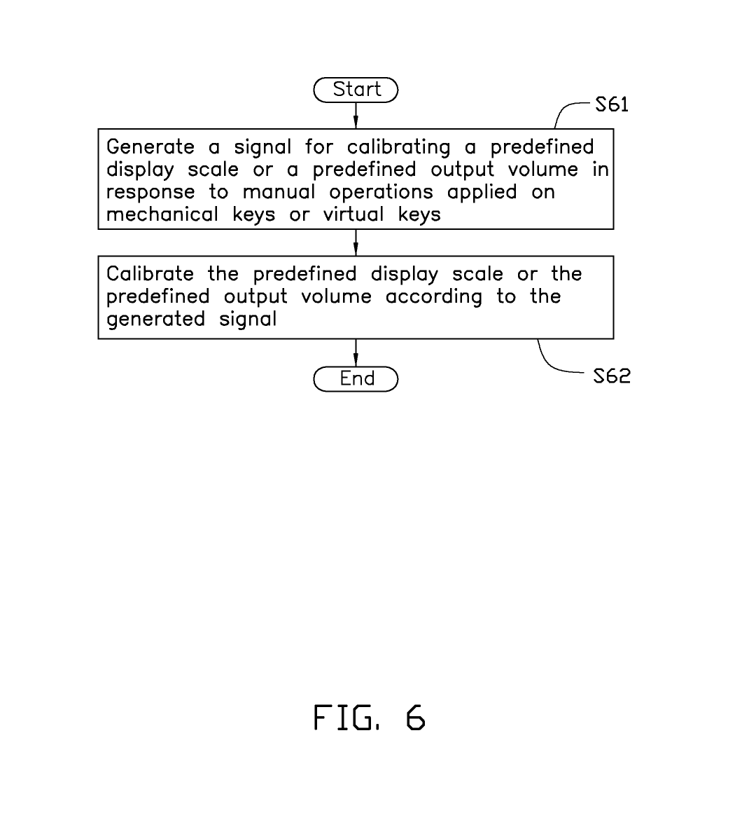

FIG. 6 is a flowchart of a method for calibrating specific parameters for the electronic device 1. The electronic device 1 includes an input unit 15. The input unit 15 includes one or more mechanical keys and/or one or more virtual keys.

In step S61, the input unit 15 generates a signal for calibrating either a predefined display scale or a predefined output volume in response to instruction operations applied on the mechanical keys or the virtual keys. In an alternative embodiment, the input unit 15 generates a signal for calibrating both a predefined display scale and a predefined output volume in response to instruction operations applied on the mechanical keys or the virtual keys.

In step S62, the calibration module 136 calibrates the predefined display scale or the predefined output volume according to the generated signal. In the alternative embodiment, the calibration module 136 calibrates both the predefined display scale and the predefined output volume according to the generated signal.

Although the present disclosure has been specifically described on the basis of various embodiments thereof, the disclosure is not to be construed as being limited thereto. Various changes or modifications may be made to the embodiments without departing from the scope and spirit of the disclosure.

What is claimed is:

1. A method for adjusting one or more specific parameters for an electronic device having a storage unit, the storage unit having stored therein a predefined picture containing a facial image, the method comprising:
generating a picture signal in response to capturing of a picture by the electronic device;
identifying a picture according to the picture signal;
determining whether the identified picture contains a facial image;
determining an adjustment type and an adjustment ratio according to comparison of the identified picture with the predefined picture when the picture contains a facial image;
adjusting the one or more specific parameters of the electronic device according to the comparison of the determined adjustment type and the determined adjustment ratio; and
outputting content from the electronic device according to the adjusted one or more specific parameters.

2. The method as described in claim 1, wherein the adjustment type is determined according to a size of a face or a size of a feature of the face in the identified picture and a size of a face or a size of a counterpart feature of the face in the predefined picture.

3. The method as described in claim 2, wherein the adjustment type being determined according to a size of a face or a size of a feature of the face in the identified picture and a size of a face or a size of a counterpart feature of the face in the predefined picture comprises:
when the size of the face or the size of the feature of the face in the identified picture is larger than the size of the face or the size of the counterpart feature of the face in the predefined picture, it is determined that the adjustment type is an adjusting down type; and
when the size of the face or the size of the feature of the face in the identified picture is the same as or smaller than the size of the face or the size of the counterpart feature of the face in the predefined picture, it is determined that the adjustment type is an adjusting up type.

4. The method as described in claim 3, wherein the adjustment ratio is determined according to the ratio between the size of the face or the size of the feature of the face in the predefined picture and the size of the face or the size of the counterpart feature of the face in the identified picture and according to a predetermined adjustment factor, with the adjustment ratio being equal to the ratio of sizes multiplied by the predetermined adjustment factor.

5. The method as described in claim 1, further comprising:
generating a signal for calibrating a predefined specific parameter in response to instruction operations applied on the electronic device; and
calibrating the predefined specific parameter according to the generated signal.

6. The method as described in claim 1, wherein the one or more specific parameters are selected from the group consisting of a display scale of a display of the electronic device and an output volume of a speaker of the electronic device.

7. The method as described in claim 1, further comprising:
capturing the picture.

8. The method as described in claim 7, wherein capturing the picture and generating a picture signal in response to capturing of the picture are performed automatically once the electronic device is activated.

9. The method as described in claim 8, wherein capturing the picture and generating a picture signal in response to capturing of the picture are again performed automatically each time a predetermined time interval elapses.

10. An electronic device, comprising:
a storage unit, configured for storing a predefined picture containing a facial image;
a camera, configured for capturing a picture and generating a corresponding picture signal;
a picture identification module, configured for identifying a picture according to the picture signal, and determining whether the identified picture contains a facial image;
an adjustment type determination module, configured for determining an adjustment type according to a comparison of the identified picture with the predefined picture when the picture contains a facial image;
an adjustment ratio calculation module, configured for determining an adjustment ratio according to the comparison of the identified picture with the predefined picture when the picture contains a facial image;
an adjusting module, configured for adjusting one or more specific parameters of the electronic device according to the determined adjustment type and the determined adjustment ratio; and
an output control module, configured for outputting content from the electronic device according to the adjusted one or more specific parameters.

11. The electronic device as described in claim 10, wherein the adjustment type determination module is configured for determining the adjustment type according to a size of a face or a size of a feature of the face in the identified picture and a size of a face or a size of a counterpart feature of the face in the predefined picture.

12. The electronic device as described in claim 11, wherein the adjustment type determination module is configured for determining whether the size of the face or the size of the feature of the face in the identified picture is larger than the size of the face or the size of the counterpart feature of the face in the predefined picture, and for determining that the adjustment type is an adjusting down type when the size of the face or the size of the feature of the face in the identified picture is larger than the size of the face or the size of the counterpart feature of the face in the predefined picture, and for determining that the adjustment type is an adjusting up type when the size of the face or the size of the feature of the face in the identified picture is the same as or smaller than the size of the face or the size of the counterpart feature of the face in the predefined picture.

13. The electronic device as described in claim 12, wherein the adjustment ratio calculation module is configured for determining the adjustment ratio according to the ratio between the size of the face or the size of the feature of the face in the predefined picture and the size of the face or the size of the counterpart feature of the face in the identified picture and according to a predetermined adjustment factor, with the adjustment ratio being equal to the ratio of sizes multiplied by the predetermined adjustment factor.

14. The electronic device as described in claim 10, further comprising:
an input unit, configured for generating a signal for calibrating any given one or more of the predefined specific parameters in response to instruction operations applied on the electronic device; and
a calibration module, configured for calibrating the given one or more of the predefined specific parameters according to the generated signal.

15. The electronic device as described in claim 10, wherein the one or more specific parameters are selected from the group consisting of a display scale of a display of the electronic device and an output volume of a speaker of the electronic device.
